(19) United States
(12) Patent Application Publication
(10) Pub. No.: US 2024/0402320 A1
(43) Pub. Date: Dec. 5, 2024

(54) SIGNAL CONTROL APPARATUS, SONAR SYSTEM, AND VEHICLE

(71) Applicant: Panasonic Automotive Systems Co., Ltd., Kanagawa (JP)

(72) Inventors: Hongjing ZHANG, Kanagawa (JP); Tadashi MORITA, Kanagawa (JP)

(21) Appl. No.: 18/679,334

(22) Filed: May 30, 2024

(30) Foreign Application Priority Data
Jun. 2, 2023 (JP) 2023-091617

(51) Int. Cl. G01S 7/52; G01S 15/931

(52) U.S. Cl. CPC G01S 7/52004; G01S 15/931

(57) ABSTRACT

Provided is a signal control apparatus that includes: an interface to which at least one sonar is connectable; a controller that executes software for controlling a transmission signal transmitted from the at least one sonar; and a software updater that updates the software. The controller compares the transmission signal, which is controlled by executing the updated software, with a reception signal received by one of the at least one sonar.

### TECHNICAL FIELD

The present disclosure relates to a signal control apparatus, a sonar system, and a vehicle.

### BACKGROUND ART

In recent years, a sonar system in which a sonar is disposed in a vehicle and a target object present around the vehicle is detected is utilized.

Further, as a technique applicable to a radar or the like, there is known a software radio system capable of supporting a new communication method by changing installed software without changing hardware (for example, see Patent Literature (hereinafter referred to as “PTL”) 1).

A sonar system mounted in a vehicle includes a sonar and an integrated ECU. FIG. 4 illustrates an existing configuration of a sonar and an integrated ECU (Electronic Control Unit).

Sonar 410 is connected to integrated ECU 420. Integrated ECU 420 transmits an ultrasound transmission instruction to sonar 410, and sonar 410 transmits data of a detected target to integrated ECU 420. Note that, there is one sonar 410 connected to integrated ECU 420 in FIG. 4, but a plurality of sonars 410 may be connected to integrated ECU 420.

Sonar 410 includes I/F (Interface) 411, modulation circuitry 412, driving circuitry 413, transmission/reception element 414, amplifier 415, BPF (Band Pass Filter) 416, A/D (Analog/Digital) converter 417, and detection processor 418.

Integrated ECU 420 includes wave transmission controller 421, I/F 422, and determiner 423.

In this sonar 410, modulation circuitry 412 performs modulation based on a transmission control signal transmitted by integrated ECU 420, and driving circuitry 413 drives transmission/reception element 414 to transmit ultrasound.

Ultrasound received by transmission/reception element 414 is amplified by amplifier 415, noise is removed by BPF 416, conversion into a digital signal is performed by A/D converter 417, detection processor 418 generates target data, and the target data are transmitted to integrated ECU 420.

### CITATION LIST

### Patent Literature

### PTL 1

Japanese Patent Application Laid-Open No. 2010-136120

### SUMMARY OF INVENTION

The present disclosure facilitates providing a technique that makes it possible to confirm whether a signal has been transmitted as assumed in a case where software is updated.

A signal control apparatus in an exemplary embodiment of the present disclosure includes: an interface to which at least one sonar is connectable; a controller that executes software for controlling a transmission signal transmitted from the at least one sonar; and a software updater that updates the software. The controller compares the transmission signal, which is controlled by executing the updated software, with a reception signal received by one of the at least one sonar.

A sonar system in an exemplary embodiment of the present disclosure includes: the signal control apparatus; and the at least one sonar.

A vehicle in an exemplary embodiment of the present disclosure is a vehicle in which the sonar system is mounted.

### Advantageous Effects of Invention

According to the technique in the present disclosure, it is possible to confirm whether a signal has been transmitted as assumed.

### BRIEF DESCRIPTION OF DRAWINGS

FIG. 1 illustrates the configuration of a vehicle in the present embodiment;

FIG. 2 illustrates details of a sonar and an integrated ECU;

FIG. 3 illustrates examples of setting information and a received waveform; and

FIG. 4 illustrates an existing configuration of a sonar and an integrated ECU.

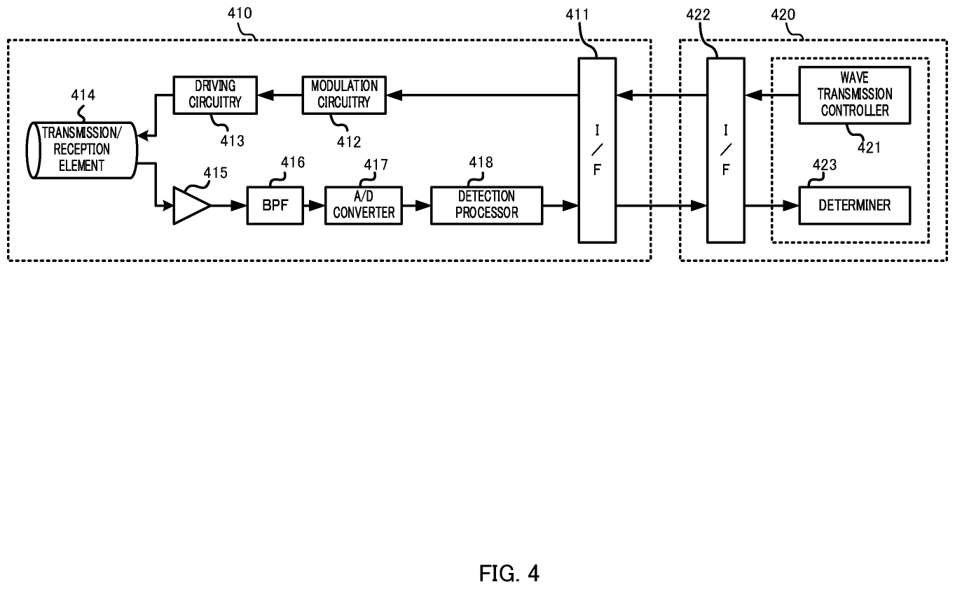

### DESCRIPTION OF EMBODIMENTS

Hereinafter, the present embodiment will be described with reference to the accompanying drawings.

### Structure

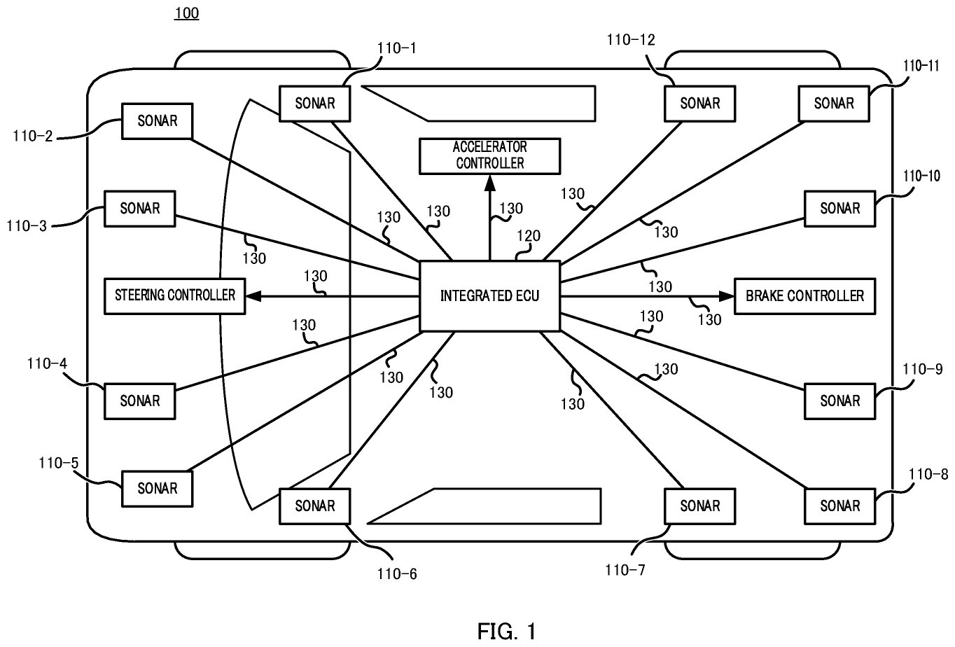

In FIG. 1, a plurality of sonars 110-1 to 110-12, an accelerator controller, a steering controller, and a brake controller, all of which are installed in vehicle 100, are connected to integrated ECU 120 via communication lines 130. Note that, hereinafter, sonars 110-1 to 110-12 will be simply referred to as sonar 110 in a case where sonars 110-1 to 110-12 are not distinguished.

Communication line 130 may be a wired line or a radio line, and a wired line and a radio line may be mixed therein. Sonars 110-1 to 110-12 may have the same configuration. Although twelve sonars are described in FIG. 1, the number of sonars may be at least one.

Sonar 110 transmits and receives ultrasound. Integrated ECU 120 controls sonar 110. Integrated ECU 120 is an example of the signal control apparatus that controls a transmission signal transmitted from sonar 110. In addition, sonar 110 and integrated ECU 120 form a sonar system. For the accelerator controller, the steering controller, and the brake controller, the accelerator operation, the steering operation, and the brake operation are controlled by the integrated ECU based on the distance and direction to an object existing around the vehicle, measured by sonar 110. Note that, the integrated ECU may control at least one of the accelerator controller, the steering controller, and the brake controller, and may also control equipment of the vehicle, which is not illustrated in FIG. 1.

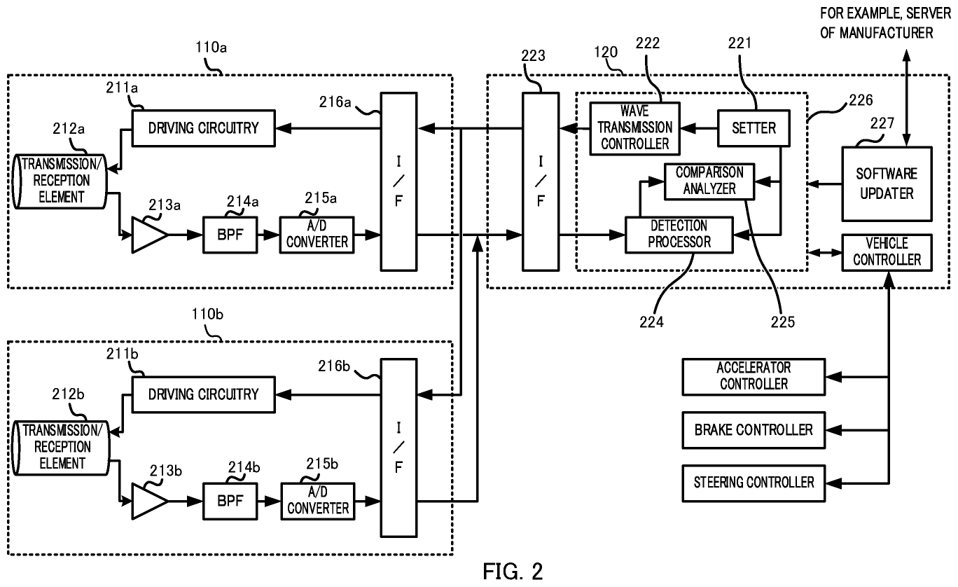

FIG. 2 illustrates a state in which two sonars 110a and 110b, the accelerator controller, the steering controller, and the brake controller are connected to integrated ECU 120. Sonars 110a and 110b are arbitrary two of sonars 110-1 to 110-12, and may be sonars 110-1 and 110-2 or may be sonars 110-2 and 110-3. Integrated ECU 120 has a ranging mode and a comparison analysis mode, obtains, in the ranging mode, the distance to an object around the vehicle and the azimuth of the object, and confirms, in the comparison analysis mode, whether a correct change has been made in a changed wave transmission.

In FIG. 2, a case where sonars 110a and 110b have the same configuration will be described, but sonars 110a and 110b may have different configurations. Further, two sonars are described in FIG. 2, but the number of sonars may be equal to or less than three.

Sonar 110a includes driving circuitry 211a, transmission/reception element 212a, amplifier 213a, BPF (Band Pass Filter) 214a, A/D (Analog/Digital) converter 215a, and I/F (Interface) 216a. Note that, one sonar 110a may include a plurality of transmission/reception elements 212a, or transmission/reception element 212a may be separated into a transmission element and a reception element.

Driving circuitry 211a drives transmission/reception element 212a by the control of integrated ECU 120. For example, driving circuitry 211a includes an identifier, and drives transmission/reception element 212a by receiving a control signal, to which the identifier of the own circuitry is given, from integrated ECU 120. Further, driving circuitry 211a converts a digital signal received from integrated ECU 120 into an analogue signal.

Transmission/reception element 212a is driven by driving circuitry 211a to transmit ultrasound. Further, transmission/reception element 212a receives ultrasound and transmits an AC signal corresponding to the received ultrasound to amplifier 213a.

Amplifier 213a amplifies the AC signal based on the ultrasound received by transmission/reception element 212a. For example, a low noise amplifier (LNA) is used for amplifier 213a.

BPF 214a removes a noise from the AC signal amplified by amplifier 213a. For example, a low pass filter (LPF), a high pass filter (HPF), or a band elimination filter (BEF) is used for BPF 214a depending on the band of a noise.

A/D converter 215a converts the AC signal, from which a noise has been removed, into a digital signal.

I/F 216a is connected to a communication line through which a signal to be inputted into and outputted from sonar 110a is transmitted.

Sonar 110b includes driving circuitry 211b, transmission/reception element 212b, amplifier 213b, BPF 214b, A/D converter 215b, and I/F 216b. Note that, one sonar 110b may include a plurality of transmission/reception elements 212b, or transmission/reception element 212b may be separated into a transmission element and a reception element.

The functions of driving circuitry 211b, transmission/reception element 212b, amplifier 213b, BPF 214b, A/D converter 215b, and I/F 216b are the same as those of driving circuitry 211a, transmission/reception element 212a, amplifier 213a, BPF 214a, A/D converter 215a, and I/F 216a, respectively, and thus, descriptions thereof will be omitted.

Integrated ECU 120 includes setter 221, wave transmission controller 222, I/F (Interface) 223, detection processor 224, comparison analyzer 225, and software updater 227. Setter 221, wave transmission controller 222, detection processor 224, and comparison analyzer 225 form controller 226.

Setter 221 sets the wave transmission waveform which is controlled by wave transmission controller 222. The setting by setter 221 enables wave transmission controller 222 to switch modulation methods among a BPSK modulation method, a pulse modulation method, a chirp modulation method, and other modulation methods.

Wave transmission controller 222 controls an ultrasonic signal transmitted by sonars 110a and 110b. For example, wave transmission controller 222 controls the wave transmission waveform of an ultrasonic signal. Further, wave transmission controller 222 switches modulation methods among a BPSK (Binary Phase Shift Keying) modulation method, a pulse modulation method, a chirp modulation method, and other modulation methods.

Wave transmission controller 222 controls the wave transmission waveform of an ultrasonic signal for each of sonars 110a and 110b. At that time, wave transmission controller 222 may use identifiers of sonars 110a and 110b.

I/F 223 is connected to a communication line through which a signal to be inputted into and outputted from integrated ECU 120 is transmitted.

Detection processor 224 detects a signal transmitted in response to ultrasound received by transmission/reception element 212 of sonars 110a and 110b. For example, detection processor 224 is notified of the content to be set to wave transmission controller 222, for example, information on the modulation method, by setter 221 in advance, and therefore determines the modulation method, the frequency, or the like based on the information and based on the received waveform.

In the ranging mode, detection processor 224 obtains the distance to a target object based on a delay time between a signal transmitted by the control of wave transmission controller 222 and a signal detected by detection processor 224. Further, detection processor 224 obtains the azimuth of the target object based on a plurality of signals of sonars 110a and 110b. Detection processor 224 outputs the obtained distance to the target object and the obtained azimuth of the target object to a vehicle controller. The vehicle controller outputs control signals to the accelerator controller, the steering controller, and the brake controller based on the distance to the target object and the azimuth of the target object. Note that, in the comparison analysis mode, detection processor 224 outputs the detected signal to comparison analyzer 225.

In the comparison analysis mode, comparison analyzer 225 determines whether assumed signals are transmitted and received based on a signal set to wave transmission controller 222 by setter 221 and a signal detected by detection processor 224.

The signal detected by detection processor 224, which will be described in detail later, is a wraparound signal received by transmission/reception element 212a in a case where transmission/reception element 212a of sonar 110a has transmitted ultrasound, or a signal of a direct wave directly received by transmission/reception element 212b of sonar 110b in a case where transmission/reception element 212a of sonar 110a has transmitted ultrasound.

In the comparison analysis mode, comparison analyzer 225 acquires, from setter 221, information on the wave transmission method for each of sonars 110a and 110b connected to integrated ECU 120, and thus, comparison analyzer 225 can determine whether assumed waveforms are transmitted from and received by sonars 110a and 110b, even in a case where different wave transmission methods exist.

Then, comparison analyzer 225 outputs, to software updater 227, information on whether an assumed waveform has been transmitted. Note that, comparison analyzer 225 may output the information to an outputter (not illustrated). The outputter is, for example, a display that outputs an image, a speaker that outputs sound, or the like.

Software updater 227 executes an instruction to update software of controller 226, for example, in a case where software updater 227 receives the instruction from a manufacturer. Note that, software updater 227 may obtain information on a software update by being connected to a server of the manufacturer or the like via a communication line, or may obtain information on a software update via an SD card, a USB (Universal Serial Bus) memory or the like. For example, software updater 227 is capable of changing the waveform of ultrasound transmitted from sonars 110a and 110b by updating software of setter 221 and wave transmission controller 222.

### Operation of Sonar System

The sonar system has a measurement mode and a comparison analysis mode. Based on the control of wave transmission controller 222, sonars 110a and 110b transmit ultrasound, and a signal corresponding to ultrasound received by sonars 110a and 110b is transmitted to integrated ECU 120.

The ultrasound transmitted by transmission/reception element 212a of sonar 110a is also received by transmission/reception element 212a due to wraparound at transmission/reception element 212a. Ultrasound due to wraparound has nearly zero delay time and is not a signal reflected by a target object, and thus, integrated ECU 120 may not utilize ultrasound due to wraparound in the measurement mode.

In the comparison analysis mode, on the other hand, integrated ECU 120 can use a signal due to wraparound for confirming a transmitted signal waveform. In this case, sonars 110a and 110b may include an attenuator between transmission/reception element 212a or 212b and amplifier 213a or 213b and may attenuate a received signal to the extent that amplifier 213a or 213b is not saturated. Further, the attenuator may be operated in a case where the delay time is shorter than a predetermined time.

Further, ultrasound transmitted by transmission/reception element 212a of sonar 110a is received directly by transmission/reception element 212b of sonar 110b. The ultrasound received directly by transmission/reception element 212b of sonar 110b is not a signal reflected by a target object, and thus, integrated ECU 120 may not utilize the ultrasound in the measurement mode. In the comparison analysis mode, on the other hand, integrated ECU 120 may use the directly received signal for confirming the transmitted signal waveform.

In the present embodiment, integrated ECU 120 confirms a transmitted signal waveform by using a wraparound signal, which is received by sonar 110a that has transmitted a transmission signal, or a reception signal, which is received by sonar 110n different from sonar 110a that has transmitted a transmission signal. Note that, integrated ECU 120 may confirm a transmitted signal waveform by using both a wraparound signal and a reception signal.

In the comparison analysis mode, integrated ECU 120 decides whether the waveform of a signal received by sonars 110a and 110b is an assumed waveform. The signal received by sonars 110a and 110b is a signal transmitted by sonar 110a or 110b, and thus, comparison analyzer 225 can decide from which of sonars 110a and 110b a signal transmitted based on the setting by setter 221 has been transmitted.

Thus, by software updated by software updater 227, it is possible to confirm whether an assumed signal has been transmitted.

Further, integrated ECU 120 detects every signal received by sonars 110a and 110b and determines the waveform of the modulation method or the like, and thus, integrated ECU 120 can confirm whether an assumed signal has been transmitted, even when the configurations of sonars 110a and 110b are not the same.

For example, even in a case where sonar 110b receives a signal of a modulation method different from a modulation method of a signal transmitted by sonar 110a, integrated ECU 120 can confirm whether an assumed signal has been transmitted.

### Setting of Modulation Method

It is also effective, depending on a target object to be detected by sonar 110, to change the modulation method of a signal to be transmitted by sonar 110.

For example, the optimum modulation method according to a target object to be detected may be used depending on the position of sonar 110 installed in vehicle 100 or the situation of vehicle 100.

In this case, setter 221 sets the modulation method for each sonar 110 connected to integrated ECU 120. Note that, the modulation method may not be set by setter 221, but may be individually set to sonar 110 in advance.

For example, in a case where the modulation method is changed depending on the position of sonar 110 installed in vehicle 100, setter 221 may apply a BPSK modulation method to a signal transmitted from sonars 110-3 and 110-4 (see FIG. 1) disposed in the front portion of vehicle 100, in order to detect a far object.

Further, setter 221 may perform setting so as to apply a pulse modulation method to a signal transmitted from sonars 110-1, 110-2, 110-5, and 110-6 disposed in the corner portions and sides of vehicle 100, in order to detect an object nearby for utilization in autonomous parking or the like.

Further, setter 221 may apply a chirp modulation method to a signal transmitted from sonars 110-2, 110-3, 110-4, and 110-5 disposed in the front portion and corner portions of vehicle 100, in order to ensure detection of a person at an intersection or the like.

Further, setter 221 may perform setting so as to apply a pulse modulation method to a signal transmitted from sonars 110-1, 110-6, 110-7, and 110-12 disposed in the sides of vehicle 100, in order to detect an object nearby for utilization in autonomous parking or the like.

In addition, setter 221 may change the modulation method of a signal to be transmitted from sonar 110 depending on the situation of the vehicle, such as whether the vehicle is being autonomously parked, the vehicle is approaching an intersection, and the vehicle is traveling at a predetermined speed or higher.

### Signal Comparison

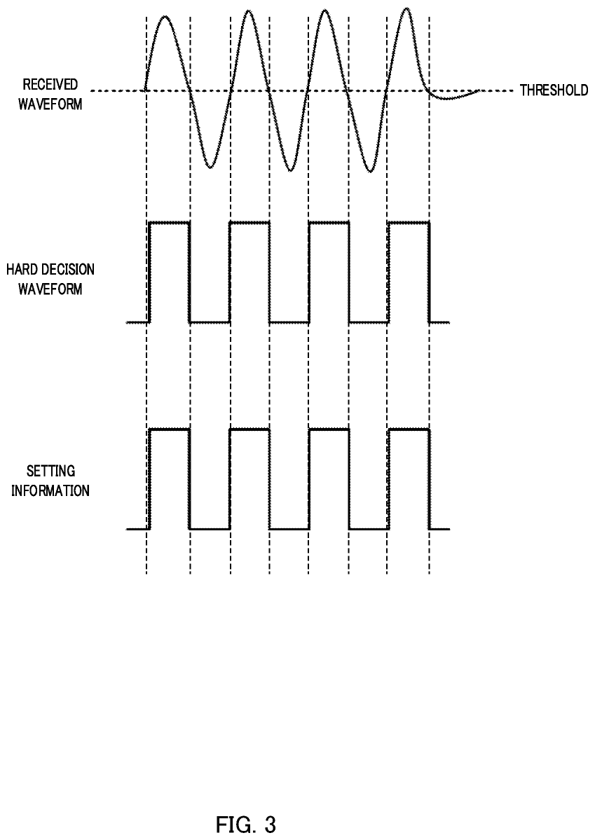

FIG. 3 illustrates examples of setting information on a signal waveform set by setter 221, a signal waveform received by sonar 110, and a waveform on which detection processor 224 has made a hard decision.

In a case where a signal waveform to be transmitted by sonar 110 is set by setter 221 by using a ROM pattern, comparison analyzer 225 confirms, by comparing the ROM pattern with a waveform obtained by making a hard decision on the waveform of a signal received by detection processor 224, whether a signal of an assumed waveform has been transmitted.

FIG. 3 illustrates a received waveform, a hard decision waveform, and a set waveform. Detection processor 224 generates a hard decision waveform in which a received signal is converted into binary data of 0 or 1 by making a decision on the received signal by using a threshold set in advance. Comparison analyzer 225 compares the hard decision waveform with the waveform set by using the ROM pattern and decides whether both coincide.

Further, comparison analyzer 225 may confirm, by comparing the frequency of a signal received by detection processor 224 with the frequency of a signal set by setter 221, whether a signal of an assumed waveform has been transmitted.

Further, comparison analyzer 225 may confirm, by comparing a signal obtained by demodulating a signal received by detection processor 224 with a signal before modulation set by setter 221, whether a signal of an assumed waveform has been transmitted, and whether information on a specific pattern set by setter 221 has been demodulated normally by detection processor 224.

Further, comparison analyzer 225 may confirm, by comparing a modulation method, which is used when a signal received by detection processor 224 is demodulated, with a modulation method set by setter 221, whether a signal of an assumed waveform has been transmitted.

Note that, the modulation methods include ASK (Amplitude Shift Keying), FSK (Frequency Shift Keying), PSK (Phase Shift Keying), and the like, and comparison analyzer 225 decides whether the modulation method is correct by comparing the amplitude, frequency, and phase of a received waveform with the set amplitude, frequency, and phase. In addition, in a case where data before modulation and data after demodulation coincide, comparison analyzer 225 may determine that a modulation method used when wave transmission controller 222 performs the modulation coincides with a modulation method used when detection processor 224 performs the demodulation.

Further, comparison analyzer 225 may confirm, by comparing a reverberation length of a signal received by detection processor 224 with a reverberation length of a transmitted signal, whether a signal of an assumed waveform has been transmitted. In this case, it is configured such that the reverberation length of the transmitted signal is known in advance.

Further, comparison analyzer 225 may confirm, by comparing the frequency of a reverberation of a signal received by detection processor 224 with the frequency of a reverberation of a signal set by setter 221, whether a signal of an assumed waveform has been transmitted. In this case, it is configured such that the frequency of the reverberation length of the transmitted signal is known in advance.

### Variations

Comparison analyzer 225 may perform, based on a confirmation result as to whether a signal of an assumed waveform has been transmitted, feedback control such that comparison analyzer 225 instructs setter 221 to adjust a signal waveform to be transmitted.

For example, in a case where the amplitude of a signal received by detection processor 224 is small, comparison analyzer 225 may output, to setter 221, an instruction to perform adjustment such that the sound pressure of ultrasound to be transmitted is increased.

Further, the determination performed by comparison analyzer 225 can also be performed by an external apparatus of integrated ECU 120. For example, the determination performed by comparison analyzer 225 may be performed by a cloud server.

Note that, the expressions “ . . . -er” and “ . . . -or” used for the constituent elements of the signal control apparatus in the embodiment described above may be replaced with other expressions such as “ . . . circuitry”, “ . . . assembly”, “ . . . device”, “ . . . unit”, or “ . . . module” as described above.

Further, the signal control apparatus in the embodiment described above may perform signal control, for example, by a CPU executing a program installed in a ROM.

The program to be executed by the signal control apparatus, however, may be recorded and provided, in an installable or executable format file, in a non-transitory computer-readable recording medium such as a CD-ROM, a flexible disk (FD), a CD-R, and a digital versatile disc (DVD). Alternatively, the program may be downloaded via a network and be executed by a computer.

Further, at least part of the functions of the signal control apparatus may be implemented by dedicated hardware circuitry including no CPU.

As described above, the signal control apparatus in the embodiment described above can be realized by software, hardware, or software in cooperation with hardware. Further, it should be noted that the signal control apparatus in the embodiment described above may be implemented as a system, an apparatus, a method, an integrated circuit, a computer program, a storage medium, or any selective combination thereof. Note that, a program product is a non-transitory computer-readable recording medium in which a computer program is recorded.

Further, each functional block of the signal control apparatus in the embodiment described above can be partly or entirely realized by an LSI such as an integrated circuit, and each processing in the signal control apparatus in the embodiment described above may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. Each processing in the signal control apparatus in the embodiment described above can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.
(1) A signal control apparatus in an exemplary embodiment of the present disclosure includes: an interface to which at least one sonar is connectable; a controller that executes software for controlling a transmission signal transmitted from the at least one sonar; and a software updater that updates the software. The controller compares the transmission signal, which is controlled by executing the updated software, with a reception signal received by one of the at least one sonar.
(2) In the signal control apparatus of (1), the reception signal is a signal received by, among the at least one sonar, a sonar that has transmitted the transmission signal.
(3) In the signal control apparatus of (1), the reception signal is a signal received directly by, among the at least one sonar, a sonar different from a sonar that has transmitted the transmission signal.
(4) In the signal control apparatus of (1), the controller compares a ROM pattern with the reception signal.
(5) In the signal control apparatus of (1), the controller compares the transmission signal before modulation with the reception signal that has been demodulated.
(6) In the signal control apparatus of (1), the controller compares a reverberation length of the transmission signal with a reverberation length of the reception signal.
(7) In the signal control apparatus of (1), the controller compares a frequency of the transmission signal with a frequency of the reception signal.
(8) In the signal control apparatus of (1), the controller compares a frequency of a reverberation of the transmission signal with a frequency of a reverberation of the reception signal.
(9) In the signal control apparatus of (1), the controller adjusts the transmission signal based on a result of a comparison of the transmission signal with the reception signal.
(10) In the signal control apparatus of (2), the controller performs control such that the reception signal is attenuated.
(11) In the signal control apparatus of (1), the controller changes a modulation method of the transmission signal according to a position in which the at least one sonar is installed.
(12) In the signal control apparatus of (1), the controller changes, according to a situation of a vehicle in which the at least one sonar is mounted, a modulation method of the transmission signal.
(13) A sonar system in an exemplary embodiment of the present disclosure includes: the signal control apparatus of (1); and the at least one sonar.
(14) A vehicle in an exemplary embodiment of the present disclosure is a vehicle in which the sonar system of (13) is mounted.

The disclosure of Japanese Patent Application No. 2023-091617, filed on Jun. 2, 2023, including the specification, drawings and abstract, is incorporated herein by reference in its entirety.

### INDUSTRIAL APPLICABILITY

The technique in the present disclosure can be utilized for a signal control apparatus, a sonar system, and a vehicle.

### REFERENCE SIGNS LIST

100 Vehicle
110 Sonar
120 Integrated ECU
130 Communication line
211a, 211b, 413 Driving circuitry
212a, 212b, 414 Transmission/reception element
213a, 213b, 415 Amplifier
214a, 214b, 416 BPF
215a, 215b, 417 A/D converter
216a, 216b, 223, 411, 422 I/F
221 Setter
222 Wave transmission controller
224, 418 Detection processor
225 Comparison analyzer
226 Controller
227 Software updater
412 Modulation circuitry
421 Wave transmission controller
423 Determiner

1. A signal control apparatus, comprising:
control circuitry, which, in operation, executes software for controlling a transmission signal transmitted from at least one sonar; and
software update circuitry, which, in operation, updates the software, wherein
the control circuitry compares the transmission signal with a reception signal, the transmission signal being controlled by executing the software, the reception signal being received by one of the at least one sonar, the software having been updated.

2. The signal control apparatus according to claim 1, wherein the reception signal is a signal received by, among the at least one sonar, a sonar that has transmitted the transmission signal.

3. The signal control apparatus according to claim 1, wherein the reception signal is a signal received directly by, among the at least one sonar, a sonar different from a sonar that has transmitted the transmission signal.

4. The signal control apparatus according to claim 1, wherein the control circuitry compares a ROM pattern with the reception signal.

5. The signal control apparatus according to claim 1, wherein the control circuitry compares the transmission signal before modulation with the reception signal that has been demodulated.

6. The signal control apparatus according to claim 1, wherein the control circuitry compares a reverberation length of the transmission signal with a reverberation length of the reception signal.

7. The signal control apparatus according to claim 1, wherein the control circuitry compares a frequency of the transmission signal with a frequency of the reception signal.

8. The signal control apparatus according to claim 1, wherein the control circuitry compares a frequency of a reverberation of the transmission signal with a frequency of a reverberation of the reception signal.

9. The signal control apparatus according to claim 1, wherein the control circuitry adjusts the transmission signal based on a result of a comparison of the transmission signal with the reception signal.

10. The signal control apparatus according to claim 2, wherein the control circuitry performs control such that the reception signal is attenuated.

11. The signal control apparatus according to claim 1, wherein the control circuitry changes a modulation method of the transmission signal according to a position in which the at least one sonar is installed.

12. The signal control apparatus according to claim 1, wherein the control circuitry changes, according to a situation of a vehicle, a modulation method of the transmission signal, the vehicle being a vehicle in which the at least one sonar is mounted.

13. A sonar system, comprising:
the signal control apparatus according to claim 1; and
the at least one sonar.

14. A vehicle, in which the sonar system according to claim 13 is mounted.

15. A signal control method, comprising:
executing an update of software for controlling a signal transmitted from at least one sonar;
executing the software and transmitting the signal from the at least one sonar, the software having been updated;
receiving the signal transmitted by one of the at least one sonar; and
comparing the signal having been transmitted with the signal having been received.

16. The signal control method according to claim 15, wherein the signal having been received is a signal received directly by, among the at least one sonar, a sonar different from a sonar that has transmitted the signal.

17. The signal control method according to claim 15, wherein in the comparing, the signal having been transmitted is a pattern outputted from a ROM.

18. The signal control method according to claim 15, wherein in the comparing, the signal having been transmitted is compared with a signal after demodulation of the signal having been received, the signal having been transmitted being a signal before modulation.

19. The signal control method according to claim 15, wherein in the comparing, a reverberation length of the signal having been transmitted is compared with a reverberation length of the signal having been received.

20. The signal control method according to claim 15, wherein:
the software includes a modulation method to be applied to the signal, and
an update of the software changes, according to a situation of a vehicle, the modulation method to be applied to the signal, the vehicle being a vehicle in which the at least one sonar is mounted.
